(19) United States
(12) Patent Application Publication
(10) Pub. No.: US 2022/0061096 A1
(43) Pub. Date: Feb. 24, 2022

(54) Wifi Channel Interference Resolution Method and Related Product

(71) Applicant: GUANGDONG OPPO MOBILE TELECOMMUNICATIONS CORP., LTD., Dongguan (CN)

(72) Inventor: Jinquan Lin, Dongguan (CN)

(21) Appl. No.: 17/519,511

(22) Filed: Nov. 4, 2021

Related U.S. Application Data
(63) Continuation of application No. PCT/CN2020/085385, filed on Apr. 17, 2020.

(30) Foreign Application Priority Data
May 6, 2019 (CN) 201910372149.5

(51) Int. Cl. H04W 74/08; H04B 17/318

(52) U.S. Cl. CPC H04W 74/0816; H04B 17/318

(57) ABSTRACT

A wireless fidelity (WiFi) channel interference resolution method and related products are provided. The method is performed by a first device. The network parameters of the first device are obtained through the first device. The first receiving sensitivity value for the first device to receive the wireless network signal is determined according to the network parameters. The receiving sensitivity for the first device to receive the wireless network signal is adjusted to the first receiving sensitivity value.

### CROSS-REFERENCE TO RELATED APPLICATION(S)

This application is a continuation of International Application No. PCT/CN2020/085385, filed on Apr. 17, 2020, which claims priority to Chinese Patent Application No. 201910372149.5, filed on May 6, 2019, the entire disclosures of both of which are incorporated herein by reference.

### TECHNICAL FIELD

This disclosure relates to the technical field of wireless networks, and in particular to a wireless fidelity (WiFi) channel interference resolution method and related products.

### BACKGROUND

With electronic devices (such as mobile phones, tablet computers, and the like) being widely used, the electronic device can support more and more applications and becomes more and more powerful. The electronic device develops toward a direction of diversification and personalization, and becomes an indispensable electronic product in user's daily life.

With development of mobile Internet, more and more users use wireless fidelity (WiFi) networks for data transmission, resulting in a greater number of the electronic devices accessing the WiFi networks. Due to limitations of a working channel of WiFi, there will be multiple electronic devices working in a same or adjacent channel(s), and channel interference between the multiple electronic devices will cause serious damage to data transmission performance of the electronic devices.

### SUMMARY

A wireless fidelity (WiFi) channel interference resolution method and related products are provided in implementations of the present disclosure.

In a first aspect, a WiFi channel interference resolution method is provided in implementations of the present disclosure. The method is performed by a first device and includes the following.

Network parameters of the first device are obtained. A first receiving sensitivity value for the first device to receive a wireless network signal is determined according to the network parameters. A present receiving sensitivity value is adjusted to the first receiving sensitivity value.

In a second aspect, an electronic device is provided in implementations of the present disclosure. The electronic device includes a processor, a memory, a communication interface, and one or more programs. The one or more programs are stored in the memory and are configured to be executed by the processor. The one or more programs include an instruction for performing an operation as described in the first aspect.

In a third aspect, a non-transitory computer-readable storage medium is provided in the present disclosure. The computer-readable storage medium is configured to store computer programs for electronic data interchange which, when executed, are operable with a computer to perform some or all operations as described in the first aspect.

### BRIEF DESCRIPTION OF DRAWINGS

In order to describe technical solutions of implementations more clearly, the following will give a brief description of accompanying drawings used for describing the implementations. Apparently, accompanying drawings described below are merely some implementations. Those of ordinary skill in the art can also obtain other accompanying drawings based on the accompanying drawings described below without creative efforts.

FIG. 1 is a schematic diagram of a scene of an electronic device operating in a wireless fidelity (WiFi) network according to implementations.

FIG. 2 is a schematic diagram of a scene of an electronic device operating in the WiFi network according to other implementations.

FIG. 3 is a schematic flowchart of a WiFi channel interference resolution method according to implementations.

FIG. 4 is a schematic flowchart of how to determine a first receiving sensitivity value in a WiFi channel interference resolution method according to implementations.

FIG. 5 is a schematic flowchart of a first device adjusting a receiving sensitivity according to implementations.

FIG. 6 is a schematic flowchart of a WiFi channel interference resolution method according to other implementations.

FIG. 7 is a schematic structural diagram of an electronic device according to implementations.

FIG. 8 is a block diagram illustrating functional units of a WiFi channel interference resolution apparatus according to implementations.

FIG. 9 is a block diagram illustrating functional units of a WiFi channel interference resolution apparatus according to other implementations.

FIG. 10 is a schematic structural diagram of an electronic device according to other implementations.

### DETAILED DESCRIPTION

In order for those skilled in the art to better understand technical solutions of implementations, technical solutions of implementations will be described clearly and completely with reference to accompanying drawings in the implementations. Apparently, implementations hereinafter described are merely some implementations, rather than all implementations, of present disclosure. All other implementations obtained by those of ordinary skill in the art based on the implementations herein without creative efforts shall fall within the protection scope of the present disclosure.

The terms “first”, “second”, and the like used in the specification, the claims, and the accompany drawings of the present disclosure are used to distinguish different objects rather than describe a particular order. In addition, the terms “include”, “comprise”, and “have” as well as variations thereof are intended to cover non-exclusive inclusion. For example, a process, method, system, product, or device including a series of steps or units is not limited to the listed steps or units. Instead, it can optionally include other steps or units that are not listed; alternatively, other steps or units inherent to the process, method, product, or device can also be included.

The term “implementation” referred to herein means that a particular feature, structure, or character described in conjunction with the implementation may be contained in at least one implementation of the present disclosure. The phrase appearing in various places in the specification does not necessarily refer to the same implementation, nor does it refer to an independent or alternative implementation that is mutually exclusive with other implementations. It is explicitly and implicitly understood by those skilled in the art that an implementation described herein may be combined with other implementations.

An electronic device referred to herein may include various handheld devices, in-vehicle devices, wearable devices, computing devices that have wireless communication functions or other processing devices connected with a wireless modem, as well as various forms of user equipments (UE), mobile stations (MS), terminal devices, and the like. For ease of description, the above-mentioned devices are collectively referred to as an electronic device.

Hereinafter, some terms will be illustrated to facilitate understanding of those skilled in the art.

Transmission coverage of a wireless network signal refers to a communication range where a transmission frame can be successfully received, and depends on transmission energy and a characteristic of radio wave transmission. Because a transmission signal will decay and is unable to be successfully received beyond a certain range, a receiver listens for the transmission signal and will not consider the transmission signal as a valid signal, and will not receive the transmission signal, and the certain range is the transmission coverage.

Listen coverage of the wireless network signal refers to a range where network signal transmission can be listened for, and depends on a sensitivity of the receiver and the characteristic of the radio wave transmission. The listen coverage is greater than the transmission coverage, because for a device, as long as the transmission signal can be listened for by the device, it is considered as in the listen coverage. However, even if the transmission signal is listened for, the transmission signal cannot be normally decoded.

A receiving sensitivity refers to a minimum threshold for a receiving end to receive the wireless network signal. The listen coverage mainly depends on the receiving sensitivity of the receiving end. The signal can be received on condition that signal energy of the signal at the receiving end is not less than a nominal receiving sensitivity. The receiving sensitivity is indicated by dBm. Generally, a nominal receiving sensitivity of the electronic device which is connected in a wireless fidelity (WiFi) network, refers to a sensitivity level with an error rate of 10⁻⁵ (99.999%) at each transmission rate. Nominal receiving sensitivities at different rates under different modulation methods are shown in a table below.

| modulation | | | | | | | | |
|---|---|---|---|---|---|---|---|---|
| method | OFDM | OFDM | OFDM | OFDM | CCK | CCK | DQPSK | DBPSK |
| transmission | 54 Mb/s | 24 Mb/s | 9 Mb/s | 6 Mb/s | 11 Mb/s | 5.5 Mb/s | 2 Mb/s | 1 Mb/s |
| rate | | | | | | | | |
| receiving | −65 | −79 | −81 | −82 | −83 | −87 | −91 | −94 |
| sensitivity | | | | | | | | |

The modulation methods include an orthogonal frequency division multiplexing (OFDM) modulation, a complementary code keying (CCK) modulation, a differential quadrature reference phase shift keying (DQPSK) modulation, and a differentially coherent binary phase shift keying (DBPSK) modulation.

RTS (Request to Send)/CTS (Clear to Send) Flow Control are two lines allow a receiver and a transmitter to alert each other to their state. A transmitter raises its RTS line, which causes an interrupt on the receiver (i.e—hey can I send some data?). If the receiver is in a position to receive data from the transmitter, it will assert its CTS line (i.e—yes you can start sending). The raising and lowering of these lines allows device drivers which implement hardware flow control code to maintain a reliable data connection between the transmitter and the receiver.

A clear channel assessment (CCA) is mainly used for two purposes: whether the signal can start to be received and whether a present channel is clear and can transmit data. A CCA detection method is not limited, and a simple and commonly used CCA detection method is to determine whether a channel is clear according to a magnitude of the signal energy.

Hereinafter, detailed description of implementations of the present disclosure will be given below.

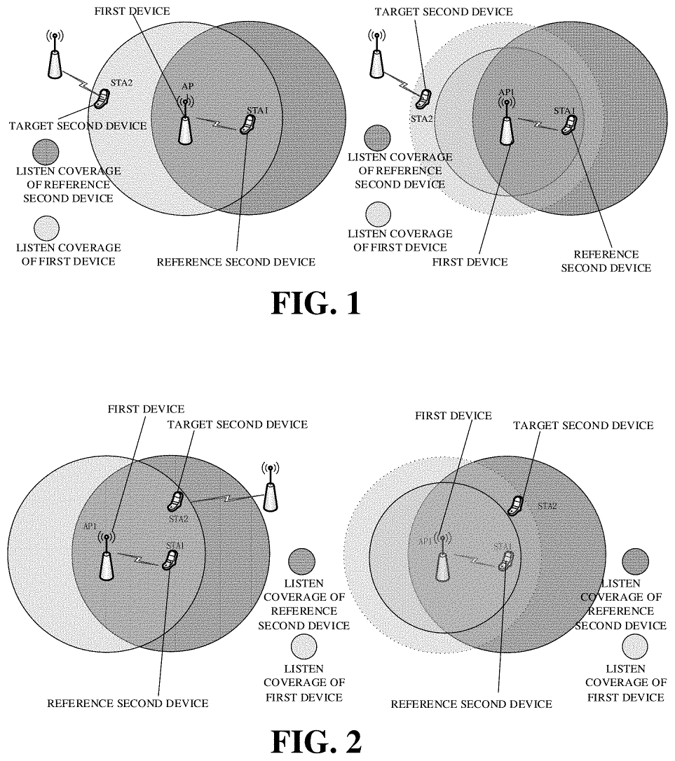

FIG. 1 and FIG. 2 are schematic diagrams of scenes of the electronic device operating in the WiFi network according to implementations. As illustrated in FIG. 1 and FIG. 2, a first device is connected with multiple second devices. The first device is a wireless access point (AP) device in the wireless network. The first device AP1 may be a router, and may also be an electronic device such as a mobile phone, a notebook computer, a palmtop, and the like. The second device is a network device for data transmission with the first device. The second device may be an electronic device such as a mobile phone, a notebook computer, a palmtop, and the like.

As illustrated in FIG. 1, a target second device STA2 is within the listen coverage of the first device AP1. When the target second device STA2 transmits data in a base station subsystem (BSS) module network, if the first device AP1 listens for the target second device STA2, and the first device AP1 is forbidden to transmit data to a reference second device STA1. Because the listen coverage is greater than the transmission coverage and the target second device STA2 is within the listen coverage of the first device AP1 instead of the transmission coverage of the first device AP1, the data transmission from the first device AP1 to the reference second device STA1 will not collide with an air packet of the target second device STA2. After the listen coverage of the first device AP1 is narrowed, because the target second device STA2 is not within the listen coverage of the first device AP1 or the listen coverage of the reference second device STA1, data transmission between the first device AP1 and the reference second device STA1 will not be affected by the target second device STA2.

As illustrated in FIG. 2, the target second device STA2 is within the listen coverage of the first device AP1 and the listen coverage of the reference second device STA1 simultaneously. Due to competition, after the listen coverage of the first device AP1 is narrowed, the target second device STA2 is not within the listen coverage of the first device AP1, but within the listen coverage of the reference second device STA1. In this case, the target second device STA2 can be determined to be a hidden wireless access point, and when the first device AP1 and the target second device STA2 transmitting packets simultaneously, collision will occur more likely. When the target second device STA2 transmit packets in its BBS module network, the first device AP1 will not receive a clear-to-send (CTS) response from the second device STA1 in response to a request-to-send (RTS) protection frame, a transmission success rate of the RTS RTS_PER will decrease, and therefore at this time, the listen coverage of the first device AP1 needs to be further increased.

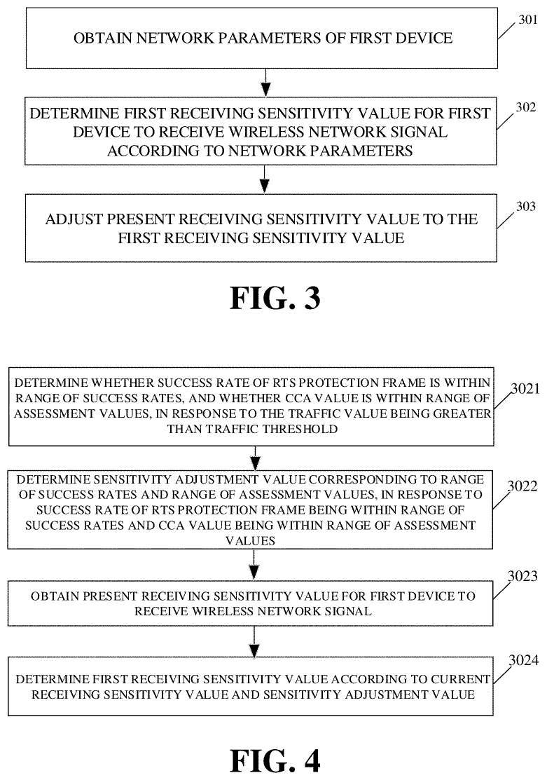

FIG. 3 is a schematic flowchart of the WiFi channel interference resolution method performed by the first device according to implementations. As illustrated in FIG. 3, the method includes the following.

At block 301, network parameters of the first device are obtained.

The first device is the AP device in the wireless network.

The network parameters include a transmission success rate of RTS protection frame RTS_PER of the first device, a CCA value CCA_Cnt, a traffic value Traffic_Value of the BBS module network in which the first device is located, and a minimum first received signal strength indication MinRssi (RSSI) among multiple RSSIs corresponding to the multiple second devices which are currently connected with the first device.

As an implementation, the network parameters of the first device can be obtained according to a time period, which may be, for example, 1 second, 0.5 second, and so on.

At block 302, a first receiving sensitivity value for the first device to receive the wireless network signal is determined according to the network parameters.

As an implementation, whether there exists a hidden wireless access point (abbreviated to “hidden point”) in a present network environment can be determined according to the transmission success rate of RTS protection frame RTS_PER of the first device. Reference can be made to FIG. 2, there exists the reference second device STA1, and the target second device STA2 is not within the listen coverage of the first device AP1, but within the listen coverage of the reference second device STA1. As an implementation, when the hidden point exists, the hidden point usually occupies the channel, the transmission success rate of RTS protection frame RTS_PER of the first device when transmitting data will decrease. Whether the present channel is busy can be determined according to the CCA value CCA_Cnt. A traffic condition of the BSS module network in which the first device is located can be determined according to the traffic value Traffic_Value. Furthermore, the first receiving sensitivity value can be determined according to whether the hidden point affects the data transmission of the first device and whether the present channel is busy.

As an implementation, at block 302, the first receiving sensitivity value for the first device to receive a wireless network signal is determined according to the network parameters as follows. Reference can be made to FIG. 4, which is a schematic flowchart of how to determine a first receiving sensitivity value in a WiFi channel interference resolution method according to implementations.

At block 3021, in response to the traffic value Traffic_Value being greater than a traffic threshold, whether the transmission success rate of RTS protection frame RTS_PER is within a range of success rates is determined, and whether the CCA value CCA_Cnt is within a range of assessment values is determined.

The traffic value Traffic_Value being greater than the traffic threshold indicates that the first device is in a state of the data transmission and the receiving sensitivity can be adjusted. When the traffic value Traffic_Value is not greater than the traffic threshold, the network parameters of the first device will continue to be obtained according to the time period until the traffic value Traffic_Value is greater than the traffic threshold.

When the transmission success rate of RTS protection frame RTS_PER is within the range of success rates and the CCA value CCA_Cnt is within the range of assessment values, whether the receiving sensitivity needs to be enlarged or reduced can be further determined. Specifically, a corresponding success rate threshold can be set for the transmission success rate of RTS protection frame RTS_PER in advance, and a corresponding threshold is set for the CCA value CCA_Cnt. After the network parameters are obtained according to the time period each time, a range to which the network parameters belong can be determined, and the receiving sensitivity can be adjusted in real time.

At block 3022, in response to the transmission success rate of RTS protection frame RTS_PER being within the range of success rates and the CCA value CCA_Cnt being within the range of assessment values, a sensitivity adjustment value adjust_Step corresponding to the range of success rates and the range of assessment values is determined.

As an implementation, the transmission success rate of RTS protection frame RTS_PER corresponds to a first upper limit value RTS_PER_HIGH_TH and a first lower limit value RTS_PER_LOW_TH, and the CCA value CCA_Cnt corresponds to a second upper limit value CCA_HIGH_TH and a second lower limit value CCA_LOW_TH. The sensitivity adjustment value adjust_Step corresponding to the range of success rates and the range of assessment values is determined as follows.

In response to the transmission success rate of RTS protection frame RTS_PER being less than the first lower limit value RTS_PER_LOW_TH and the CCA value CCA_Cnt being greater than the second upper limit value CCA_HIGH_TH, that the sensitivity adjustment value adjust_Step indicates increasing the present receiving sensitivity value by a target value is determined. In response to the transmission success rate of RTS protection frame RTS_PER being greater than the first lower limit value RTS_PER_LOW_TH or the CCA value CCA_Cnt being less than the second upper limit value CCA_HIGH_TH, that the sensitivity adjustment value adjust_Step indicates decreasing the present receiving sensitivity value by the target value is determined.

When the transmission success rate of RTS protection frame RTS_PER is less than the first lower limit value RTS_PER_LOW_TH, it indicates that there exists the hidden point in the current network environment and the hidden point often accesses the channel for data transmission. When the CCA value CCA_Cnt is greater than the second upper limit value CCA_HIGH_TH, it indicates that the present network environment is noisy and the channel is often occupied by other second devices. In this case, the receiving sensitivity can be increased. Specifically, that the sensitivity adjustment value adjust_Step indicates increasing the present receiving sensitivity value by the target value is determined, and the target value may be, for example, 2 dbm. For example, an original receiving sensitivity is −105 dBm, that is, an original receiving sensitivity value is 105 dBm, and then the receiving sensitivity value (i.e., the first receiving sensitivity value) after adjustment is 107 dBm.

When the transmission success rate of RTS protection frame RTS_PER is greater than the first upper limit value RTS_PER_HIGH_TH, it can be determined that there is no hidden point in the current network environment, that is, there is no reference second network device which is not within the listen coverage of the first device but within the listen coverage of the reference second device, or it indicates that the hidden node does not affect the data transmission of the first device. When the CCA value CCA_Cnt is less than the second lower limit value CCA_LOW_TH, it indicates that the present network environment is relatively clean and there are more clear channels. In this case, the receiving sensitivity can be reduced. Specifically, that the sensitivity adjustment value adjust_Step indicates decreasing the present receiving sensitivity value by the target value is determined. For example, an original receiving sensitivity is −105 dBm, that is, an original receiving sensitivity is 105 dBm, the receiving sensitivity after adjustment is 103 dBm.

At block 3023, a present receiving sensitivity value for the first device to receive the wireless network signal is obtained.

As an implementation, after the receiving sensitivity is adjusted each time, the present receiving sensitivity value can be saved. When the receiving sensitivity is to be adjusted next time, the first receiving sensitivity value can be determined according to the present receiving sensitivity value and a determined sensitivity adjustment value adjust_Step.

At block 3024, the first receiving sensitivity value is determined according to the present receiving sensitivity value and the sensitivity adjustment value adjust_Step.

Specifically, when the sensitivity adjustment value adjust_Step indicates increasing the present receiving sensitivity value by the target value, the target value can be added to the present receiving sensitivity value, in other words, the first receiving sensitivity value=the present receiving sensitivity value+the target value. When the sensitivity adjustment value adjust_Step indicates decreasing the present receiving sensitivity value by the target value, the target value can be subtracted from the present receiving sensitivity value, in other words, the first receiving sensitivity value=the present receiving sensitivity value−the target value.

When the sensitivity adjustment value is the positive target value, the present receiving sensitivity value is increased, and thus the listen coverage is increased; when the sensitivity adjustment value is the negative target value, the present receiving sensitivity value is decreased, and thus the listen coverage is decreased.

As an implementation, the method may further include the following.

Multiple reference transmission success rates of RTS protection frame under multiple transmission rates are obtained. A first target transmission rate, which is closest to a first transmission rate and greater than the first transmission rate, is determined in the multiple transmission rates. A second target transmission rate, which is closest to a second transmission rate and less than the second transmission rate, is determined in the multiple transmission rates, and the second transmission rate is less than the first transmission rate. A reference transmission success rate corresponding to the first target transmission rate is determined to be the first upper limit value RTS_PER_HIGH_TH and a reference transmission success rate corresponding to the second target transmission rate is determined to be the first lower limit value RTS_PER_LOW_TH. Multiple reference CCA values under multiple transmission rates are obtained. A third target transmission rate, which is closest to a third transmission rate and greater than the third transmission rate, is determined in the multiple transmission rates. A fourth target transmission rate, which is closest to a fourth transmission rate and less than the fourth transmission rate, is determined in the multiple transmission rates, and the fourth transmission rate is less than the third transmission rate. A CCA value corresponding to the third target transmission rate is determined to be the second lower limit value CCA_LOW_TH, and a CCA value corresponding to the fourth target transmission rate is determined to be the second upper limit value CCA_HIGH_TH.

In this implementation, the multiple reference transmission success rates of RTS protection frame under multiple different transmission rates can be obtained. The multiple transmission rates each corresponds to a reference transmission success rate. When the first transmission rate is greater than the first transmission rate, it indicates that there is no hidden point in the present network environment or the hidden point does not affect the data transmission of the first device. Therefore, the first target transmission rate, which is closest to a first transmission rate and greater than the first transmission rate, can be determined in the multiple transmission rates, and the reference transmission success rate corresponding to the first target transmission rate is determined to be the first upper limit value RTS_PER_HIGH_TH. When the first transmission rate is less than the second transmission rate, it indicates that there exists the hidden point in the present network environment and the hidden point often accesses the channel for the data transmission between the second device and the first device. Therefore, the second target transmission rate, which is closest to a second transmission rate and less than the second transmission rate, can be determined in the multiple transmission rates, and the reference transmission success rate corresponding to the second target transmission rate is determined to be the first lower limit value RTS_PER_LOW_TH.

In addition, in this implementation, the multiple reference CCA values under the multiple different transmission rates can be obtained. The multiple transmission rates each corresponds to a reference CCA value. When the second transmission rate is greater than a third transmission rate, it indicates that the present network environment is relatively clean and there are more clear channels. Therefore, the third target transmission rate, which is closest to the third transmission rate and greater than the third transmission rate, can be determined in the multiple transmission rates, and the reference CCA value corresponding to the third target transmission rate is determined to be the second lower limit value CCA_LOW_TH. When the second transmission rate is less than a fourth transmission rate, it indicates that the present network environment is noisy and the channel is often occupied by other second devices. Therefore, the fourth target transmission rate, which is closest to a fourth transmission rate and less than the fourth transmission rate, can be determined in the multiple transmission rates, and the reference CCA value corresponding to the fourth target transmission rate is determined to be the second upper limit value CCA_HIGH_TH.

The range of success rates can be set by obtaining the multiple reference transmission success rates of RTS protection frame corresponding to multiple different transmission rates. The range of assessment values can be set by obtaining the multiple CCA values corresponding to the multiple different transmission rates. Furthermore, a relationship between the transmission success rate of RTS protection frame RTS_PER and the range of success rates of the first device can be determined, and a relationship between the CCA value CCA_Cnt and the range of assessment values can be determined. Moreover, the receiving sensitivity of the first device can be adjusted.

At block 303, a present receiving sensitivity value is adjusted to the first receiving sensitivity value.

As an implementation, after the first device determines the first receiving sensitivity value, the present receiving sensitivity value for the first device to receive the wireless network signal is adjusted to the first receiving sensitivity value. As such, the network performance of the first device and the Internet experience of the users in an environment with channel interference can be improved.

As an implementation, at block 303, a present receiving sensitivity value for the first device to receive the wireless network signal is adjusted to the first receiving sensitivity value as follows.

A present modulation mode of the wireless network signal of the first device is determined. The first receiving sensitivity value is written into a hardware register corresponding to the modulation method and is made effective.

As illustrated in the table, the first device can operate in different modulation methods and can operate in multiple modulation methods simultaneously. Therefore, as an implementation, the present modulation method of the first device can be determined, and then the first receiving sensitivity value is written into the hardware register corresponding to the modulation method and is made effective, so as to achieve adjustment of the receiving sensitivity.

As an implementation, the network parameters further include the minimum first RSSI MinRssi among multiple RSSIs corresponding to the multiple second devices which are currently connected with the first device, and the method further includes the following.

After the first receiving sensitivity value for the first device to receive the wireless network signal is determined according to the network parameters, when the first receiving sensitivity value is not less than the minimum first RSSI MinRssi and the first receiving sensitivity value is not less than a second RSSI FixedRssiBoundary, the second RSSI FixedRssiBoundary is a minimum RSSI that the first device can listen for, the first receiving sensitivity value is updated to a smaller one of the minimum first RSSI MinRssi and the second RSSI FixedRssiBoundary.

When the first device adjusts the receiving sensitivity, it needs to be ensured that the first device can listen for all the second devices which are connected with the first device. Therefore, it needs to be ensured that an adjusted receiving sensitivity value is less than the minimum first RSSI MinRssi among the multiple RSSIs corresponding to the multiple second devices which are currently connected with the first device. In addition, in order to ensure that the first device can be connected by the second device, the listen coverage of the first device is unable to be narrowed without limitation, and it needs to be ensured that the adjusted receiving sensitivity value is less than the second RSSI FixedRssiBoundary that the first device can listen for. Therefore, after the first receiving sensitivity value for the first device to receive the wireless network signal is determined according to the network parameters, the first device can compare the first receiving sensitivity value with the first RSSI and the second RSSI FixedRssiBoundary respectively. When the first receiving sensitivity value is not less than the minimum first RSSI MinRssi and the first receiving sensitivity value is not less than the second RSSI FixedRssiBoundary, the second RSSI FixedRssiBoundary is the minimum RSSI that the first device can listen for, the first receiving sensitivity value is updated to the smaller one of the minimum first RSSI MinRssi and the second RSSI FixedRssiBoundary, so as to obtain a new first receiving sensitivity value. Then the receiving sensitivity for the first device to receive the wireless network signal is adjusted to the updated first receiving sensitivity value. As such, the channel interference can be avoided and the network performance can be improved, while ensuring that the first device listen for all connected second devices.

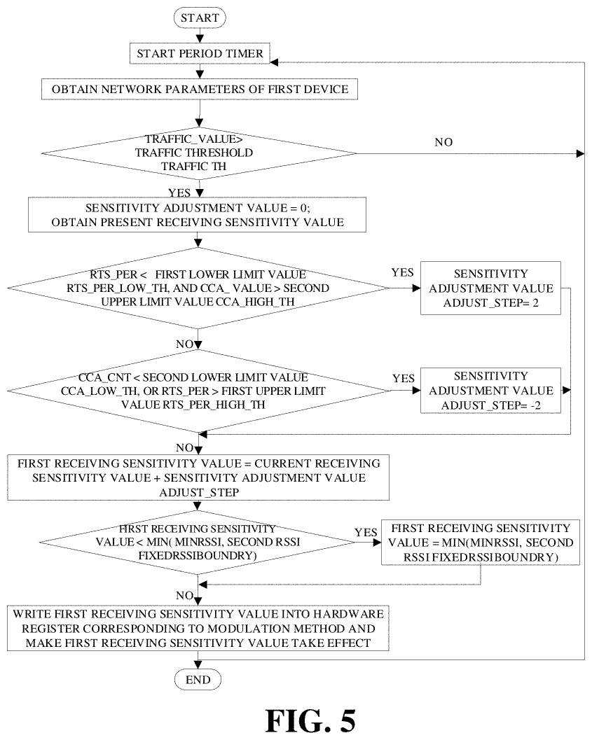

FIG. 5 is a schematic flowchart of the first device adjusting the receiving sensitivity according to implementations. As illustrated in FIG. 5, a period timer is started, and the network parameters of the first device are obtained in the time period. When the traffic value Traffic_Value is greater than the traffic threshold, whether the transmission success rate of RTS protection frame RTS_PER is within the range of success rates and whether the CCA value CCA_Cnt is within the range of assessment values are further determined. When the traffic value Traffic_Value is not greater than the traffic threshold, the network parameters can continue to be obtained in the time period. When the transmission success rate of RTS protection frame RTS_PER is less than the first lower limit value RTS_PER_LOW_TH and the CCA value CCA_Cnt is greater than the second upper limit value CCA_HIGH_TH, that the sensitivity adjustment value adjust_Step indicates increasing the present receiving sensitivity value by the target value such as 2 dbm is determined. When the transmission success rate of RTS protection frame RTS_PER is greater than the first upper limit value RTS_PER_HIGH_TH or the CCA value CCA_Cnt is less than the second lower limit value CCA_LOW_TH, that the sensitivity adjustment value adjust_Step indicates decreasing the present receiving sensitivity value by the target value such as −2 dbm is determined. Then the first receiving sensitivity value is determined according to the present receiving sensitivity value and the sensitivity adjustment value adjust_Step. When the first receiving sensitivity value is not less than the minimum first RSSI MinRssi and the first receiving sensitivity value is not less than the second RSSI FixedRssiBoundary, the second RSSI FixedRssiBoundary is the minimum RSSI that the first device can listen for, the first receiving sensitivity value is updated to the smaller one of the minimum first RSSI MinRssi and the second RSSI FixedRssiBoundary, so as to obtain the new first receiving sensitivity value. Finally, the first receiving sensitivity value is written into the hardware register corresponding to the modulation method and is made effective.

As can be seen that, the WiFi channel interference resolution method as described in the present disclosure is performed by the first device, the network parameters of the first device are obtained through the first device, the first receiving sensitivity value for the first device to receive the wireless network signal is determined according to the network parameters, and the present receiving sensitivity value for the first device to receive the wireless network signal is adjusted to the first receiving sensitivity value. As such, the network performance of the first device and the Internet experience of the users in the environment with channel interference can be improved, by adjusting the receiving sensitivity of the first device.

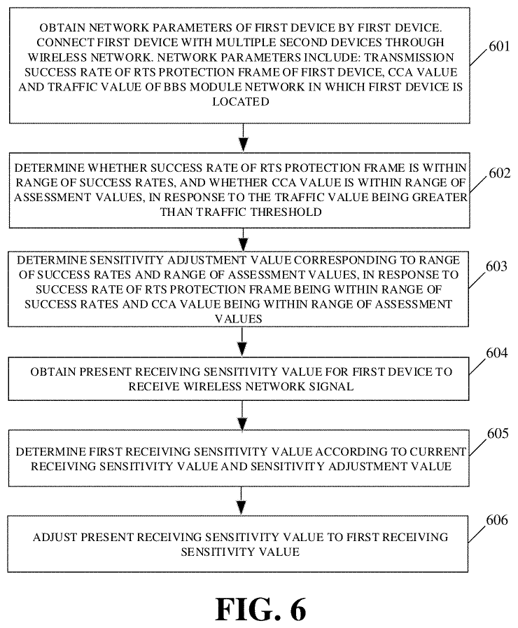

Similar to implementations illustrated in FIG. 3, FIG. 6 is a schematic flowchart of the WiFi channel interference resolution method according to other implementations. As illustrated in FIG. 6, the method includes the following.

At block 601, the first device obtains network parameters of the first device. The first device is connected with more second devices through a wireless network. The network parameters include the transmission success rate of RTS protection frame RTS_PER of the first device, the CCA value CCA_Cnt, and the traffic value Traffic_Value of the BSS module network in which the first device is located.

At block 602, whether the transmission success rate of RTS protection frame RTS_PER is within a range of success rates and whether the CCA value CCA_Cnt is within a range of assessment values are determined, in response to the traffic value Traffic_Value being greater than the traffic threshold.

At block 603, the sensitivity adjustment value adjust_Step corresponding to the range of success rates and the range of assessment values is determined, in response to the transmission success rate of RTS protection frame RTS_PER being within the range of success rates and the CCA value CCA_Cnt being within the range of assessment values.

At block 604, the present receiving sensitivity value for the first device to receive the wireless network signal is obtained.

At block 605, the first receiving sensitivity value is determined according to the present receiving sensitivity value and the sensitivity adjustment value adjust_Step.

At block 606, the present receiving sensitivity value for the first device to receive the wireless network signal is adjusted to the first receiving sensitivity value.

For specific descriptions of operations at block 601 to block 606, reference can be made to descriptions of corresponding operations of the WiFi channel interference resolution method as illustrated in FIG. 3, which will not be repeated here.

As can be seen that the WiFi channel interference resolution method as described in the present disclosure is performed by the first device. The network parameters of the first device are obtained through the first device. When the traffic value Traffic_Value is greater than the traffic threshold, whether the transmission success rate of RTS protection frame RTS_PER is within the range of success rates and whether the CCA value CCA_Cnt is within the range of assessment values are determined. When the transmission success rate of RTS protection frame RTS_PER is within the range of success rates and the CCA value CCA_Cnt is within the range of assessment values, the sensitivity adjustment value adjust_Step corresponding to the range of success rates and the range of assessment values is determined, and the present receiving sensitivity value for the first device to receive the wireless network signal is obtained. The first receiving sensitivity value is determined according to the present receiving sensitivity value and the sensitivity adjustment value adjust_Step. The receiving sensitivity value for the first device to receive the wireless network signal is adjusted to the first receiving sensitivity value. As such, the first receiving sensitivity value of the first device is determined according to the network parameters of the first device. Furthermore, the network performance for the first device and Internet experience of users in an environment with channel interference can be improved by adjusting the receiving sensitivity of the first device flexibly.

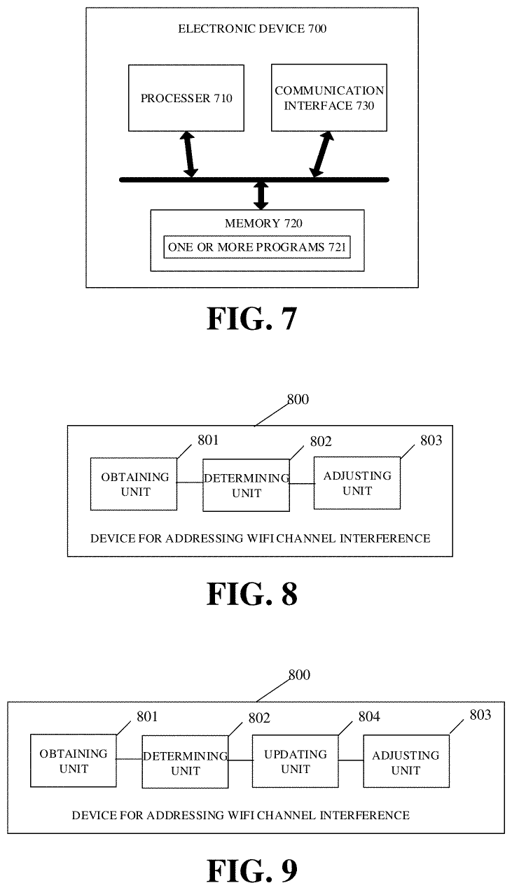

Similar to implementations illustrated in FIG. 3 and FIG. 6, FIG. 7 is a schematic structural diagram of the electronic device according to implementations. As illustrated in FIG. 7, the electronic device 700 includes a processor 710, a memory 720, a communication interface 730, and one or more programs 721. The one or more programs 721 are stored in the memory 720 and are configured to be executed by the processor 710. The one or more programs 721 includes instructions for performing the following methods.

The network parameters of the first device are obtained. The first receiving sensitivity value for the first device to receive a wireless network signal is determined according to the network parameters. The present receiving sensitivity value for the first device to receive the wireless network signal is adjusted to the first receiving sensitivity value.

As an implementation, the first device is connected with the multiple second devices through the wireless network. The network parameters include the transmission success rate of RTS protection frame RTS_PER of the first device, the CCA value CCA_Cnt, and the traffic value Traffic_Value of the BSS module network in which the first device is located. In terms of determining the first receiving sensitivity value for the first device to receive the wireless network signal according to the network parameters, the one or more programs 721 include the instructions for performing the following methods.

When the traffic value Traffic_Value is greater than the traffic threshold, whether the transmission success rate of RTS protection frame RTS_PER is within the range of success rates and whether the CCA value CCA_Cnt is within the range of assessment values are determined. When the transmission success rate of RTS protection frame RTS_PER is within the range of success rates and the CCA value CCA_Cnt is within the range of assessment values, the sensitivity adjustment value adjust_Step corresponding to the range of success rates and the range of assessment values is determined. The present receiving sensitivity value for the first device to receive the wireless network signal is obtained. The first receiving sensitivity value is determined according to the present receiving sensitivity value and the sensitivity adjustment value adjust_Step.

As an implementation, the transmission success rate of RTS protection frame RTS_PER corresponds to the first upper limit value RTS_PER_HIGH_TH and the first lower limit value RTS_PER_LOW_TH, and the CCA value CCA_Cnt corresponds to the second upper limit value CCA_HIGH_TH and the second lower limit value CCA_LOW_TH. In terms of determining the sensitivity adjustment value adjust_Step corresponding to the range of success rates and the range of assessment values, the one or more programs 721 include the instructions for performing the following methods.

When the transmission success rate of RTS protection frame RTS_PER is less than the first lower limit value RTS_PER_LOW_TH and the CCA value CCA_Cnt is greater than the second upper limit value CCA_HIGH_TH, that the sensitivity adjustment value adjust_Step indicates increasing the present receiving sensitivity value by the target value is determined. When the transmission success rate of RTS protection frame RTS_PER is greater than the first lower limit value RTS_PER_LOW_TH or the CCA value CCA_Cnt is less than the second upper limit value CCA_HIGH_TH, that the sensitivity adjustment value adjust_Step indicates decreasing the present receiving sensitivity value by the target value is determined.

As an implementation, the network parameters further include the minimum first RSSI MinRssi among the multiple RSSIs corresponding to the multiple second devices which are currently connected with the first device. The one or more programs 721 includes the instructions for performing the following methods.

After the first receiving sensitivity value for the first device to receive the wireless network signal is determined according to the network parameters, when the first receiving sensitivity value is not less than the minimum first RSSI MinRssi and the first receiving sensitivity value is not less than the second RSSI FixedRssiBoundary, the second RSSI FixedRssiBoundary is the minimum RSSI that the first device can listen for, the first receiving sensitivity value is updated to the smaller one of the minimum first RSSI MinRssi and the second RSSI FixedRssiBoundary.

As an implementation, in terms of adjusting the present receiving sensitivity value for the first device to receive the wireless network signal to the first receiving sensitivity value, the one or more programs 721 include the instructions for performing the following methods.

The present modulation mode of the wireless network signal of the first device is determined. The first receiving sensitivity value is written into the hardware register corresponding to the modulation method and is made effective.

The foregoing solution of the implementations of the present disclosure is mainly described from the viewpoint of execution process of the method. It can be understood that, in order to implement the above functions, the electronic device includes hardware structures and/or software modules corresponding to the respective functions. Those skilled in the art should readily recognize that, in combination with units and method steps described in the implementations disclosed herein, the present disclosure can be implemented in hardware or a combination of the hardware and computer software. Whether a function is implemented by way of the hardware or hardware driven by the computer software depends on the particular application and design constraints of the technical solution. Those skilled in the art may use different methods to implement the described functions for each particular application, but such implementations should not be considered as beyond the scope of the present disclosure.

According to the implementations of the present disclosure, functional units may be divided for the electronic device in accordance with the foregoing method examples. For example, each functional unit may be divided according to each function, and two or more functions may be integrated in one processing unit. The above-mentioned integrated unit can be implemented in the form of hardware or software functional units. It should be noted that the division of units in the implementations is schematic, and is merely a logical function division, and there may be other division manners in actual implementation.

FIG. 8 is a block diagram illustrating functional units of a functional unit of a WiFi channel interference resolution apparatus 800 according to implementations. The WiFi channel interference resolution apparatus 800 is performed by the first device and includes an obtaining unit 801, a determining unit 802, and an adjusting unit 803. The obtaining unit 801 is configured to obtain network parameters of the first device. The determining unit 802 is configured to determine, according to the network parameters, the first receiving sensitivity value for the first device to receive the wireless network signal. The adjusting unit 803 is configured to adjust a present receiving sensitivity value for the first device to receive the wireless network signal to the first receiving sensitivity value.

As an implementation, the first device is connected with the multiple second devices through the wireless network. The network parameters include the transmission success rate of RTS protection frame RTS_PER of the first device, the CCA value CCA_Cnt, and the traffic value Traffic_Value of the BSS module network in which the first device is located. In terms of determining the first receiving sensitivity value for the first device to receive the wireless network signal according to the network parameters, the determining unit 802 is configured to determine whether the transmission success rate of RTS protection frame RTS_PER is within the range of success rates, and determine whether the CCA value CCA_Cnt is within a range of assessment values, when the traffic value Traffic_Value is greater than the traffic threshold; determine the sensitivity adjustment value adjust_Step corresponding to the range of success rates and the range of assessment values, when the transmission success rate of RTS protection frame RTS_PER is within the range of success rates and the CCA value CCA_Cnt is within the range of assessment values; obtain the present receiving sensitivity value for the first device to receive the wireless network signal; determine the first receiving sensitivity value according to the present receiving sensitivity value and the sensitivity adjustment value adjust_Step.

As an implementation, the transmission success rate of RTS protection frame RTS_PER corresponds to the first upper limit value RTS_PER_HIGH_TH and the first lower limit value RTS_PER_LOW_TH, and the CCA value CCA_Cnt corresponds to the second upper limit value CCA_HIGH_TH and the second lower limit value CCA_LOW_TH. In terms of determining the sensitivity adjustment value adjust_Step corresponding to the range of success rates and the range of assessment values, the determining unit 802 is configured to determine that the sensitivity adjustment value adjust_Step indicates increasing the present receiving sensitivity by the target value, when the transmission success rate of RTS protection frame RTS_PER is less than the first lower limit value RTS_PER_LOW_TH and the CCA value CCA_Cnt is greater than the second upper limit value CCA_HIGH_TH, and determine that the sensitivity adjustment value adjust_Step indicates decreasing the present receiving sensitivity value by the target value, when the transmission success rate of RTS protection frame RTS_PER is greater than the first upper limit value RTS_PER_HIGH_TH or the CCA value CCA_Cnt is less than the second lower limit value CCA_LOW_TH.

As an implementation, FIG. 9 is a block diagram illustrating functional units of the WiFi channel interference resolution apparatus in FIG. 8 according to other implementations. As illustrated in FIG. 9, the network parameters further include the minimum first RSSI MinRssi among the multiple RSSIs corresponding to the multiple second devices which are currently connected with the first device. FIG. 9 further includes an updating unit 804, compared with FIG. 8. The updating unit 804 is configured to update the first receiving sensitivity value to the smaller one of the minimum first RSSI MinRssi and the second RSSI FixedRssiBoundary, when the first receiving sensitivity value is not less than the minimum first RSSI MinRssi and the first receiving sensitivity value is not less than the second RSSI FixedRssiBoundary, the second RSSI FixedRssiBoundary is the minimum RSSI that the first device can listen for, after the determining unit 802 determines, according to the network parameters, the first receiving sensitivity value for the first device to receive the wireless network signal.

As an implementation, the obtaining unit 801 is further configured to obtain the multiple reference transmission success rates of RTS protection frame under the multiple transmission rates.

The determining unit 802 is further configured to determine the first target transmission rate which is closest to the first transmission rate and greater than the first transmission rate in the multiple transmission rates; determine the second target transmission rate which is closest to the second transmission rate and less than the second transmission rate in the multiple transmission rates, and the second transmission rate is less than the first transmission rate; determine the reference transmission success rate corresponding to the first target transmission rate to be the first lower limit value RTS_PER_LOW_TH and determine the reference transmission success rate corresponding to the second target transmission rate to be the first upper limit value RTS_PER_HIGH_TH.

The obtaining unit 801 is further configured to obtain the multiple reference CCA values under the multiple transmission rates.

The determining unit 802 is further configured to determine the third target transmission rate which is closest to the third transmission rate and greater than the third transmission rate in the multiple transmission rates; determine the fourth target transmission rate which is closest to the fourth transmission rate and less than the fourth transmission rate in the multiple transmission rates, and the fourth transmission rate is less than the third transmission rate; determine the CCA value corresponding to the third target transmission rate to be the second upper limit value CCA_HIGH_TH, and determine the CCA value corresponding to the fourth target transmission rate to be the second upper limit value CCA_HIGH_TH.

As an implementation, in terms of adjusting the present receiving sensitivity value for the first device to receive the wireless network signal to the first receiving sensitivity value, the adjusting unit 803 is configured to determine the present modulation mode of the wireless network signal of the first device and write the first receiving sensitivity value into the hardware register corresponding to the modulation method and make the first receiving sensitivity value effective.

As an implementation, the network parameters further include the minimum first RSSI MinRssi among the multiple RSSIs corresponding to the multiple second devices which are currently connected with the first device. The updating unit 804 is further configured to update the first receiving sensitivity value to the smaller one of the minimum first RSSI MinRssi and the second RSSI FixedRssiBoundary, when the first receiving sensitivity value is not less than the minimum first RSSI MinRssi and the first receiving sensitivity value is not less than the second RSSI FixedRssiBoundary, the second RSSI FixedRssiBoundary is the minimum RSSI that the first device can listen for, after the determining unit 802 determines, according to the network parameters, the first receiving sensitivity value for the first device to receive the wireless network signal.

As can be seen that, the WiFi channel interference resolution apparatus as described in the present disclosure is performed by the first device. The network parameters of the first device are obtained through the first device. The first receiving sensitivity value for the first device to receive a wireless network signal is determined according to the network parameters. The present receiving sensitivity value for the first device to receive the wireless network signal is adjusted to the first receiving sensitivity value. As such, the network performance of the first device and the Internet experience of the users in an environment with channel interference can be improved, by adjusting the receiving sensitivity of the first device.

It is to be noted that, the electronic device described in the device implementation of the disclosure is presented in the form of functional units. The term “unit” used herein should be understood as the broadest meaning as possible, and an object for implementing functions defined by each “unit” may be, for example, an integrated circuit (ASIC), a single circuit, a processor (shared, dedicated, or chipset) and a memory for executing one or more software or firmware programs, a combinational logic circuit, and/or other suitable components that can achieve the above described functions.

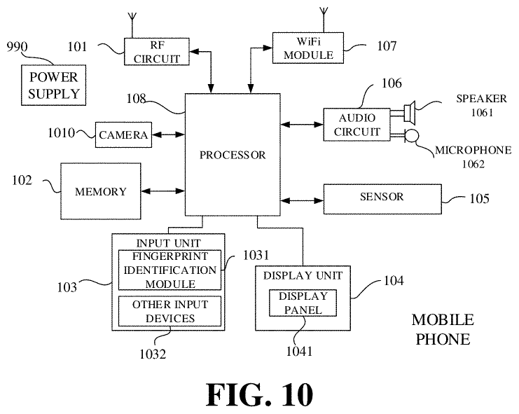

Implementations of the present disclosure also provide another electronic device. For ease of description, only parts related to implementations of the present disclosure are described and for specific technical details that are not described, reference can be made to method implementations of the present disclosure. As illustrated in FIG. 10, the electronic device can include a mobile phone, a tablet computer, a personal digital assistant (PDA), a point of sales (POS), an in-vehicle computer, and other terminal devices. A mobile phone will be taken as an example of the electronic device in the following.

FIG. 10 is a schematic structural diagram of a part of structures of the mobile phone that is related to the electronic device provided in implementations. As illustrated in FIG. 10, the mobile phone includes: a radio frequency (RF) circuit 101, a memory 102, an input unit 103, a display unit 104, a sensor 105, an audio circuit 106, a WiFi module 107, a processor 108, a power supply 109, and other elements. It will be appreciated by those skilled in the art that the present disclosure is not limited by the mobile phone as illustrated in FIG. 10. More or fewer elements than that as illustrated in FIG. 10 can be included, some elements may be or combined, or elements can be arranged differently.

Hereinafter, detailed description of each element of the mobile phone will be given below with reference of FIG. 10.

The RF circuit 101 can be configured to receive and transmit information. Generally, the RF circuit 101 includes but is not limited to an antenna, at least one amplifier, a transceiver, a coupler, a low noise amplifier (LNA), a duplexer, and the like. Furthermore, the RF circuit 101 may also be configured to communicate with a network and other devices via wireless communication. The above wireless communication may use any communication standard or protocol, which includes but is not limited to global system of mobile communication (GSM), general packet radio service (GPRS), code division multiple access (CDMA), wideband code division multiple access (WCDMA), long term evolution (LTE), E-mail, short messaging service (SMS), and so on.

The memory 102 is configured to store software programs and modules. The processor 108 is configured to execute various function applications and data processing of the mobile phone by running the software programs and the modules stored in the memory 102. The memory 102 can mainly include a program storage area and a data storage area. The program storage area can store an operating system, at least one application required by function, and so on. The data storage area can store data created according to use of the mobile phone, and so on. In addition, the memory 102 can include a high-speed random access memory (RAM), and can further include a non-volatile memory such as at least a disk storage device, a flash device, or other non-volatile solid storage devices.

The input unit 103 is configured to receive input digital or character information and to generate key signal input associated with user setting and functional control of the mobile phone. Specifically, the input unit 103 may include a fingerprint identification module 1031 and other input devices 1032. The fingerprint identification module 1031 is configured to collect use's fingerprint data thereon. The input unit 103 can further include other input devices 1032 in addition to the fingerprint identification module 1031. Specifically, the other input devices 1032 can include, but are not limited to, one or more of a touch screen, a physical keyboard, a functional key (such as a volume control key, a switch key, and so on), a track ball, a mouse, and an operating rod.

The display unit 104 is configured to display information input by the user, information provided for the user, or various menus of the mobile phone. The display unit 104 can include a display panel 1041. As an implementation, the display panel 1041 may be configured in the form of a liquid crystal display (LCD), an organic or inorganic light-emitting diode, and so on.

The mobile phone may also include at least one sensor 105, such as a light sensor, a motion sensor, a pressure sensor, a temperature sensor, and other sensors. Specifically, the light sensor may include an ambient light sensor (or a light ray sensor) and a proximity sensor. The ambient light sensor can be configured to adjust the brightness of the mobile phone's backlight according to ambient lights, so as to adjust the brightness of the display panel 1041. The proximity sensor can be configured to turn off the display panel 1041 and/or backlight when the mobile phone reaches nearby the ear. As one kind of motion sensor, an accelerometer sensor can be configured to detect the magnitude of acceleration in different directions (typically three axes) and the accelerometer sensor can also be configured to detect the magnitude and direction of gravity when mobile phone is stationary. The accelerometer sensor can also be configured to identify mobile-phone gestures related applications (such as vertical and horizontal screen switch, related games, magnetometer attitude calibration), and can be used for vibration-recognition related functions (such as a pedometer, or percussion), and so on. The mobile phone can also be equipped with other sensors such as a gyroscope, a barometer, a hygrometer, a thermometer, an infrared sensor, etc., which will not be repeated herein.

The audio circuit 106 may include m microphones, where m is a positive integer greater than 1. Audio data can be captured via microphones. The audio circuit 106, the speaker 1061, and the microphone 1062 can provide an audio interface between the user and the mobile phone. On one hand, the audio circuit 106 can be configured to convert received audio data into electrical signals and transfer the electrical signals to the speaker 1061; the speaker 1061 is configured to convert the electrical signals received into sound signals for output. On the other hand, the microphone 1062 is configured to convert the received sound signals into electrical signals, which will be received and then converted into audio data by the audio circuit 106. The audio data is then transmitted to the processor 108 to be processed. The audio data processed by the processor 108 is transmitted to another mobile phone via an RF circuit 101 for example or is output to the memory 102 for further processing.

WiFi belongs to a short-range wireless transmission technology. With aid of the WiFi module 107, the mobile phone may assist the user in E-mail receiving and sending, webpage browsing, access to streaming media, and the like. WiFi provides users with wireless broadband Internet access. Although the WiFi module 107 is illustrated in FIG. 10, it is to be noted that the WiFi module 107 is not essential to the mobile phone and can be omitted according to actual needs without departing from the essential nature of the present disclosure.

The processor 108 is a control center of the mobile phone, and is configured to connect all parts of the whole mobile phone by utilizing various interfaces and lines, to run or execute the software programs and/or the modules stored in the memory 102, and to call data stored in the memory 102 to execute various functions and data processing of the mobile phone, so as to monitor the mobile phone as a whole. As an implementation, the processor 108 can include one or more processing units. As an implementation, the processor 108 may be integrated with an application processor and a modulation-demodulation processor. The application processor is mainly configured to process an operating system, a user interface, an application program, and the like, and the modulation-demodulation processor is mainly configured to process wireless communication. It can be noted that the modulation-demodulation processor may not be integrated into the processor 108.

The mobile phone also includes a power supply 109 (e.g., a battery) that supplies power to various elements. As an implementation, the power supply 109 may be logically connected with the processor 108 via a power management system to achieve management of charging, discharging, and power consumption through the power management system.

The mobile phone also includes a camera 1010, and the camera 1010 is configured to capture images and videos and transmit the images and videos captured to the processor 108 for processing.

Although not illustrated, the mobile phone may include a Bluetooth® module, etc., and the present disclosure will not elaborate herein.

The methods of the foregoing implementations as illustrated in FIG. 3 and FIG. 6 can be implemented based on the structure of the mobile phone.

A computer storage medium is also provided in implementations of the present disclosure. The computer storage medium is configured to store programs which, when executed, are operable to execute some or all of the operations of any of the methods as described in the above-described method implementations. The computer includes the electronic device.

A computer program product is also provided in implementations of the present disclosure. The computer program product includes a non-transitory computer-readable storage medium that stores computer programs. The computer programs are operable with a computer to execute some or all operations of any of the methods as described in the above-described method implementations. The computer program product may be a software installation packet. The computer includes the electronic device.

It is to be noted that, for the sake of simplicity, the foregoing method implementations are described as a series of action combinations. However, it will be appreciated by those skilled in the art that the present disclosure is not limited by the sequence of actions described. According to the present disclosure, certain steps or operations may be performed in other order or simultaneously. Besides, it will be appreciated by those skilled in the art that the implementations described in the specification are exemplary implementations and the actions and modules involved are not necessarily essential to the present disclosure.

In the foregoing implementations, the description of each implementation has its own emphasis. For the parts not described in detail in an implementation, reference may be made to related descriptions in other implementations.

In the implementations of the present disclosure, it is to be noted that, the apparatus disclosed in implementations provided herein may be implemented in other manners. For example, the apparatus implementations described above are merely illustrative; for instance, the division of the unit is only a logical function division and there can be other manners of division during actual implementations; for example, multiple units or components may be combined or may be integrated into another system, or some features may be ignored, omitted, or not performed. In addition, coupling or direct coupling or communication connection between each illustrated or discussed component may be indirect coupling or communication connection via some interfaces, devices, or units, and may be electrical connection, or other forms of connection.

The units described as separate components may or may not be physically separated, and the components illustrated as units may or may not be physical units, that is, they may be in the same place or may be distributed to multiple network elements. All or part of the units may be selected according to actual needs to achieve the purpose of the technical solutions of the implementations.

In addition, the functional units in various implementations of the present disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device, and so on) to perform all or part of the steps described in the various implementations of the present disclosure. The memory includes various medium capable of storing program codes, such as a USB (universal serial bus) flash disk, a read-only memory (ROM), a RAM, a removable hard disk, a disk, a compact disc (CD), or the like.

It will be noted by those of ordinary skill in the art that all or a part of the various methods of the implementations described above may be accomplished by means of a program to instruct associated hardware, where the program may be stored in a computer-readable memory, which may include a flash memory, a ROM, a RAM, a disk or a CD, and so on.

The implementations of the present disclosure are described in detail above, specific examples are used herein to describe the principle and implementation manners of the present disclosure. The description of the above implementations is merely used to help understand the method and the core idea of the present disclosure. Meanwhile, those skilled in the art may make modifications to the specific implementation manners and the application scope according to the idea of the present disclosure. In summary, the contents of the specification should not be construed as limiting the present disclosure.

What is claimed is:

1. A method of wireless fidelity (WiFi) channel interference resolution, performed by a first device and comprising:
obtaining network parameters of the first device;
determining a first receiving sensitivity value according to the network parameters; and
adjusting a present receiving sensitivity value to the first receiving sensitivity value.

2. The method of claim 1, wherein the first device is connected with a plurality of second devices through a wireless network, the network parameters comprise a transmission success rate of a request-to-send (RTS) protection frame of the first device, a clear channel assessment (CCA) value, and a traffic value of a base station subsystem (BSS) module network in which the first device is located; wherein determining a first receiving sensitivity value according to the network parameters comprises:
determining that the transmission success rate of RTS protection frame is within a range of success rates, and the CCA value is within a range of assessment values, in response to the traffic value being greater than a traffic threshold;
determining a sensitivity adjustment value corresponding to the range of success rates and the range of assessment values;
obtaining the present receiving sensitivity value for the first device to receive a wireless network signal; and
determining the first receiving sensitivity value according to the present receiving sensitivity value and the sensitivity adjustment value.

3. The method of claim 2, wherein the transmission success rate of RTS protection frame corresponds to a first upper limit value and a first lower limit value, and the CCA value corresponds to a second upper limit value and a second lower limit value, wherein determining the sensitivity adjustment value corresponding to the range of success rates and the range of assessment values comprises:
determining that the sensitivity adjustment value indicates increasing the present receiving sensitivity value by a target value, in response to the transmission success rate of RTS protection frame being less than the first lower limit value and the CCA value being greater than the second upper limit value; and
determining that the sensitivity adjustment value indicates decreasing the present receiving sensitivity value by the target value, in response to the transmission success rate of RTS protection frame being greater than the first upper limit value or the CCA value being less than the second lower limit value.

4. The method of claim 2, wherein the network parameters further comprise a first received signal strength indication (RSSI), the first RSSI is a minimum RSSI among a plurality of RSSIs corresponding to the plurality of second devices which are currently connected with the first device, and the method further comprises:
after determining the first receiving sensitivity value according to the network parameters,
updating the first receiving sensitivity value to a smaller one of the first RSSI and a second RSSI, in response to the first receiving sensitivity value being not less than the first RSSI and the first receiving sensitivity value being not less than the second RSSI, wherein the second RSSI is a minimum RSSI that the first device can listen for.

5. The method of claim 3, further comprising:
obtaining a plurality of reference transmission success rates of RTS protection frame and a plurality of reference CCA values under a plurality of transmission rates;
determining, among the plurality of transmission rates, a first target transmission rate which is closest to a first transmission rate and greater than the first transmission rate, and determining, among the plurality of transmission rates, a second target transmission rate which is closest to a second transmission rate and less than the second transmission rate, wherein the second transmission rate is less than the first transmission rate;
determining a reference transmission success rate corresponding to the first target transmission rate to be the first upper limit value and determining a reference transmission success rate corresponding to the second target transmission rate to be the first lower limit value;
determining, among the plurality of transmission rates, a third target transmission rate which is closest to a third transmission rate and greater than the third transmission rate, and determining, among the plurality of transmission rates, a fourth target transmission rate which is closest to a fourth transmission rate and less than the fourth transmission rate, wherein the fourth transmission rate is less than the third transmission rate; and
determining a CCA value corresponding to the third target transmission rate to be the second lower limit value, and determining a CCA value corresponding to the fourth target transmission rate to be the second upper limit value.

6. The method of claim 1, wherein adjusting the present receiving sensitivity value to the first receiving sensitivity value comprises:
determining a present modulation mode of a wireless network signal of the first device; and
writing the first receiving sensitivity value into a hardware register corresponding to a modulation method and making the first receiving sensitivity value effective.

7. The method of claim 6, wherein the network parameters further comprise a first RSSI, the first RSSI is a minimum RSSI among a plurality of RSSIs corresponding to a plurality of second devices which are currently connected with the first device, and the method further comprises:
after determining the first receiving sensitivity value according to the network parameters,
updating the first receiving sensitivity value to a smaller one of the first RSSI and a second RSSI, in response to the first receiving sensitivity value being not less than the first RSSI and the first receiving sensitivity value being not less than the second RSSI, wherein the second RSSI is a minimum RSSI that the first device can listen for.

8. The method of claim 4, wherein adjusting the present receiving sensitivity value to the first receiving sensitivity value comprises:
determining a present modulation mode of the wireless network signal of the first device; and
writing the first receiving sensitivity value into a hardware register corresponding to a modulation method and making the first receiving sensitivity value effective.

9. The method of claim 5, wherein adjusting the present receiving sensitivity value to the first receiving sensitivity value comprises:
determining a present modulation mode of the wireless network signal of the first device; and
writing the first receiving sensitivity value into a hardware register corresponding to a modulation method and making the first receiving sensitivity value effective.

10. The method of claim 6, wherein modulation method comprises at least one of: an orthogonal frequency division multiplexing (OFDM) modulation, a complementary code keying (CCK) modulation, a differential quadrature reference phase shift keying (DQPSK) modulation, and a differentially coherent binary phase shift keying (DBPSK) modulation.

11. An electronic device, comprising a processor, a memory, a communication interface, and one or more programs, wherein the one or more programs are stored in the memory and are configured to be executed by the processor, and the one or more programs comprise instructions for:
obtaining network parameters of a first device;
determining a first receiving sensitivity value according to the network parameters; and
adjusting a present receiving sensitivity value to the first receiving sensitivity value.

12. The electronic device of claim 11, wherein the first device is connected with a plurality of second devices through a wireless network; the network parameters comprise a transmission success rate of request to send (RTS) protection frame of the first device, a clear channel assessment (CCA) value, and a traffic value of a base station subsystem (BSS) module network in which the first device is located; and in terms of determining for the first device to receive the wireless network signal according to the network parameters, the one or more programs comprise instructions for:
determining that the transmission success rate of RTS protection frame is within a range of success rates, and the CCA value is within a range of assessment values, in response to the traffic value being greater than a traffic threshold;
determining a sensitivity adjustment value corresponding to the range of success rates and the range of assessment values;
obtaining a present receiving sensitivity value for the first device to receive the wireless network signal; and
determining the first receiving sensitivity value according to the present receiving sensitivity value and the sensitivity adjustment value.

13. The electronic device of claim 12, wherein the transmission success rate of RTS protection frame corresponds to a first upper limit value and a first lower limit value, and the CCA value corresponds to a second upper limit value and a second lower limit value; and in terms of determining the sensitivity adjustment value corresponding to the range of success rates and the range of assessment values, the one or more programs comprise instructions for:
determining that the sensitivity adjustment value indicates increasing the present receiving sensitivity value by a target value, in response to the transmission success rate of RTS protection frame being less than the first lower limit value and the CCA value being greater than the second upper limit value; and
determining that the sensitivity adjustment value indicates decreasing the present receiving sensitivity value by the target value, in response to the transmission success rate of RTS protection frame being greater than the first upper limit value or the CCA value being less than the second lower limit value.

14. The electronic device of claim 12, wherein the network parameters further comprise a first received signal strength indication (RSSI), the first RSSI is a minimum RSSI among a plurality of RSSIs corresponding to the plurality of second devices which are currently connected with the first device, and the one or more programs further comprise instructions for:
after determining the first receiving sensitivity value according to the network parameters,
updating the first receiving sensitivity value to a smaller one of the first RSSI and a second RSSI, in response to the first receiving sensitivity value being not less than the first RSSI and the first receiving sensitivity value being not less than the second RSSI, wherein the second RSSI is a minimum RSSI that the first device can listen for.

15. The electronic device of claim 13, wherein the one or more programs further comprise instructions for:
obtaining a plurality of reference transmission success rates of RTS protection frame and a plurality of reference CCA values under a plurality of transmission rates;
determining, among the plurality of transmission rates, a first target transmission rate which is closest to a first transmission rate and greater than the first transmission rate, and determining, among the plurality of transmission rates, a second target transmission rate which is closest to a second transmission rate and less than the second transmission rate, wherein the second transmission rate is less than the first transmission rate;
determining a reference transmission success rate corresponding to the first target transmission rate to be the first upper limit value and determining a reference transmission success rate corresponding to the second target transmission rate to be the first lower limit value;
determining, among the plurality of transmission rates, a third target transmission rate which is closest to a third transmission rate and greater than the third transmission rate, and determining, among the plurality of transmission rates, a fourth target transmission rate which is closest to a fourth transmission rate and less than the fourth transmission rate, wherein the fourth transmission rate is less than the third transmission rate; and
determining a CCA value corresponding to the third target transmission rate to be the second lower limit value, and determining a CCA value corresponding to the fourth target transmission rate to be the second upper limit value.

16. The electronic device of claim 11, wherein in terms of adjusting the present receiving sensitivity value to the first receiving sensitivity value, the one or more programs comprise instructions for:
determining a present modulation method of the first device for a wireless network signal; and
writing the first receiving sensitivity value into a hardware register corresponding to the modulation method and making the first receiving sensitivity value take effect.

17. A non-transitory computer-readable storage medium configured to store computer programs for electronic data interchange which, when executed, are operable with a computer to:
obtain network parameters of a first device;
determine a first receiving sensitivity value according to the network parameters; and
adjust a present receiving sensitivity value to the first receiving sensitivity value.

18. The non-transitory computer-readable storage medium of claim 17, wherein the first device is connected with a plurality of second devices through a wireless network; the network parameters comprise a transmission success rate of request to send (RTS) protection frame of the first device, a clear channel assessment (CCA) value, and a traffic value of a base station subsystem (BSS) module network in which the first device is located; and in terms of determining the first receiving sensitivity value according to the network parameters, the computer programs for electronic data interchange which, when executed, are operable with the computer to:
determine that the transmission success rate of RTS protection frame is within a range of success rates, and the CCA value is within a range of assessment values, in response to the traffic value being greater than a traffic threshold;
determine a sensitivity adjustment value corresponding to the range of success rates and the range of assessment values;
obtain the present receiving sensitivity value for the first device to receive the wireless network signal; and
determine the first receiving sensitivity value according to the present receiving sensitivity value and the sensitivity adjustment value.

19. The non-transitory computer-readable storage medium of claim 18, wherein the transmission success rate of RTS protection frame corresponds to a first upper limit value and a first lower limit value, and the CCA value corresponds to a second upper limit value and a second lower limit value; and in terms of determining the sensitivity adjustment value corresponding to the range of success rates and the range of assessment values, the computer programs for electronic data interchange which, when executed, are operable with the computer to:
determine that the sensitivity adjustment value indicates increasing the present receiving sensitivity value by a target value, in response to the transmission success rate of RTS protection frame being less than the first lower limit value and the CCA value being greater than the second upper limit value; and
determine that the sensitivity adjustment value indicates decreasing the present receiving sensitivity value by the target value, in response to the transmission success rate of RTS protection frame being greater than the first upper limit value or the CCA value being less than the second lower limit value.

20. The non-transitory computer-readable storage medium of claim 18, wherein the network parameters further comprise a first received signal strength indication (RSSI), the first RSSI is a minimum RSSI among a plurality of RSSIs corresponding to the plurality of second devices which are currently connected with the first device, and the computer programs for electronic data interchange which, when executed, are further operable with the computer to:
after determining the first receiving sensitivity value according to the network parameters,
update the first receiving sensitivity value to a less one of the first RSSI and a second RSSI, in response to the first receiving sensitivity value being not less than the first RSSI and the first receiving sensitivity value being not less than the second RSSI, the second RSSI being a minimum RSSI which is listened for by the first device.
